(19) United States
(12) Patent Application Publication
(10) Pub. No.: US 2007/0193088 A1
(43) Pub. Date: Aug. 23, 2007

(54) Electric sign with flat light source

(76) Inventors: Robert L. Lemberger, Santa Ana, CA (US); Terry S. Lynn, Carlsbad, CA (US); Robbin J. Hunt, Carlsbad, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 11/325,374

(22) Filed: Jan. 4, 2006

(51) Int. Cl. G09F 13/22

(52) U.S. Cl. 40/544

(57) ABSTRACT

An electrically powered sign is provided having a flat transparent sign display panel containing an alphanumeric sign message, a flat light source placed in close proximity, or directly affixed, to the sign display panel, a frame of varying configurations supporting the flat light source and the sign display such that the flat light source, when powered on, shines light through the sign display making the sign message visible in low light conditions, and a serviceable portable power source to provide electrical power to the flat light source, attached to the frame, whereby the electrically powered sign is self-contained and portable, and capable of being placed anywhere for displaying the sign displays alphanumeric sign message.

### FIELD OF THE INVENTION

The present invention relates generally to electric signs with flat light sources, and more particularly to a sign incorporating a flat light source as a backlight, thereby providing a sign readable at night or in low light conditions which is controllable and energy efficient.

### BACKGROUND OF THE INVENTION

Although many lighting systems have been devised in the past, very few have remote site operation capability. One of these systems incorporates a flood light illuminating a sign by emitting a high voltage light from a point in front of the sign. This type of sign is not only expensive to operate, unusable in remote locations but is often seen as a generator of light pollution.

Plastic signage incorporating a light source behind the translucent portion of the sign have been designed, however, again the design requires the attachment of a separate source of electricity. Very often, this light is fluorescent or high voltage incandescent and again emits light pollution and requires a source of the electricity so, prevents location of signage out of range of such external sources of power and are relatively expensive to operate.

As a consequence, there has been a need for an improved electric sign with flat light source which may be operated by battery power and thus provide light for signage or portions of signage in remote sites, which is energy efficient for use in remote or distant sites, which is also efficient, flexible and economical to manufacture and which is weather resistant and vandalism and theft resistant.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

The present invention provides an improved electric sign with flat light source arrangement which requires virtually no added expense in producing an illuminated sign in a remote location. The battery operated lighting will provide for the illumination of all or portions of a sign and can do so in remote locations with little or no light pollution. This sign arrangement provides for the greatest flexibility in remote or distant locations which may be far from electrical outlets such as curbside real estate signs.

This particular sign arrangement provides a flat light source which operates on low levels of electricity. The flat light source may utilize a battery for power. A light sensor may then trigger a timer which then triggers an on or off relay switch and which may be adjustable to conserve on electricity.

The sign may be attached to a standard real estate yard sign. This “sign” can be attached to the standard real estate yard sign in multiple positions. The “sign” can be done as a simple rider, as a rider on top and along the side, or it can be hanging able the sign. The power runs along the main vertical beam to the electronics container.

The flat light source is mounted on a frame. This frame is made from weather resistant alloys, custom built to house the flat light source and frame.

The electronics container shows the interior view, the container holds the batteries, the solar sensor, the circuit board, the inverter and all other necessary electrical components. The electronics container is made from a hard plastic which is weather resistant and contains a locking mechanism for preventing vandalism and theft.

The principle object of this invention is to provide for a sign arrangement that includes a flat light source which operates on low levels of electricity, with flexibility for a variety of locations, security from theft and protection from elements. The embodiments of the sign may be real estate yard signs, sidewalk signs, billboard signs, sandwich signs and hanging signs and many other types of signs.

Another object of this invention is to create a signage arrangement that is flexible, attachable to a pre-existing frame in a variety of positions, may be made to order as an integral portion of the sign, economical to operate, protected from vandalism, theft or inclement weather and is provided with an integrated power source.

Briefly, the present invention is directed to an electrically powered lighted sign having a flat light source to illuminate a sign display message. The flat light sources are typically light emitting capacitors (LECs) having very low energy consumption, thereby being energy efficient to operate. The flat light source is integrated into a frame portion of the sign, and a power source is provided requiring no additional or external electricity wired in for use. The flat light source may be provided with sensors and timers by which the light is switched on when low light conditions occur, making the sign optimally visible over unlighted signs. When light sources are too low to provide readable light for a non-illuminated sign, flat panel light bulb back lighted signs may effectively and conveniently operate without the additional expense of having to provide external electrical power lines. The source of electrical energy typically comes from one or more batteries, such as compact 6 volt batteries, which make power available to the signs without wired electrical power sources in the near vicinity. Because the power sources are integrated into the sign, the electric sign with flat light source will be efficient and economical to produce and use, and because they are self-contained and portable, provide the largest possible coverage area for signs without requiring externally supplied wired electrical power service.

Therefore, an electrically powered sign is provided having a flat transparent sign display panel containing an alphanumeric or graphic sign message, a flat light source placed in close proximity, or directly affixed, to the sign display panel, a frame of varying configurations supporting the flat light source and the sign display such that the flat light source, when powered on, shines light through the sign display making the sign message visible in low light conditions, and a serviceable portable power source to provide electrical power to the flat light source, attached to the frame, whereby the electrically powered sign is self-contained and portable, and capable of being placed anywhere for displaying the sign display's alphanumeric or graphic sign message.

It must be clearly understood at this time although the preferred embodiment of the invention consists of the frame, the flat light source and the electronics container with batteries, solar sensor, circuit board compose the electrical sign and frame combinations which is an addition to a standard curbside real estate sign, that many conventional signage configurations exist that will achieve a similar operation and they will also be fully covered within the scope of this patent.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIGS. 1A, 1B and 1C depict an overview of a frontal view of a standard real estate sign incorporating embodiments of this invention, the “rider” sign may be used as a simple rider (A), as a rider on top and along the side (B), or it can be hanging above the sign (C), constructed in accordance with the present invention;

FIG. 2 depicts a frontal view again showing the “sign” configured in multiple locations on the real estate yard sign frame, constructed in accordance with the present invention;

FIG. 3 depicts a partial cross sectional view of one end of a sign frame configuration, illustrating one sign mounting arrangement and the power supply wires which lead to the flat light source, constructed in accordance with the present invention;

FIG. 4 depicts a cross sectional view of a frame and the flat light source mounting, constructed in accordance with the present invention;

FIGS. 5A, 5B, 5C, 5D and 5E illustrate in order, a side elevational view showing the sign face (A), a top view of one end (B), a closed end view (C), a cross sectional view (D), and a top view (E), constructed in accordance with the present invention;

FIG. 6 depicts an electronics container with a cross section showing the interior view, with batteries, a solar sensor, the circuit board, the inverter and all other necessary electrical components, constructed in accordance with the present invention;

FIG. 7 is a block diagram illustrating the basic wiring logic of the flat light source, light sensor, and timer, constructed in accordance with the present invention;

FIGS. 8A, 8B and 8C depicts an embodiment of a sidewalk sign showing a frontal view of the sign (A), with a top view (B), and a side view (C), constructed in accordance with the present invention;

FIGS. 9A and 9B shows an embodiment of a billboard sign in accordance with the present invention with a frontal view (A), and a side view (B), constructed in accordance with the present invention;

FIGS. 10A and B depict an embodiment of a sandwich sign in accordance with the present invention with a side view (A), and a frontal view (B), constructed in accordance with the present invention;

FIGS. 11A and 11B is an embodiment of a hanging sign in accordance with the present invention with a frontal view (A), and a side view (B), constructed in accordance with the present invention;

FIGS. 12A and 12B depicts a double slotted insert embodiment of a sign with a side view with a frame outer covering (A), and a slotted side insert without a frame outer covering (B), constructed in accordance with the present invention;

FIGS. 13A and 13B depicts an alternate double slotted insert embodiment of a sign illustrating a side view with a frame outer covering (A), and a slotted side insert without a frame outer covering (B), constructed in accordance with the present invention;

FIGS. 14A and 14B depicts yet another double slotted insert embodiment of a sign illustrating a side view with a frame outer covering (A), and a slotted side insert without a frame outer covering (B), constructed in accordance with the present invention;

FIGS. 15A, 15B and 15C depicts a single slotted insert embodiment of a sign illustrating a side view with a frame outer covering (A), a slotted side insert without a frame outer covering (B), and a top view (C); and

FIGS. 16A, 16B, 16C, 16D and 16E depicts an alternate frame arrangement embodiment with slotted frame members (A) and (C), and end caps (B) illustrating a screw fastening mechanism (D) and (E), constructed in accordance with the present invention.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

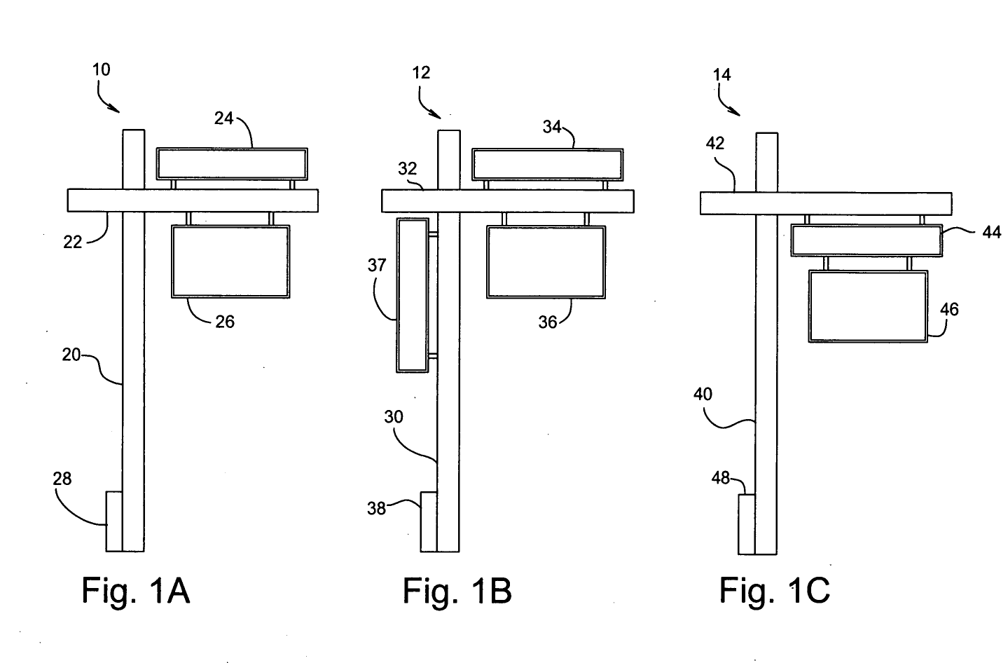

For a fuller understanding of the nature and objects of the invention, reference should be had to the following detailed description taken in conjunction with the accompanying drawings wherein similar parts of the invention are identified by like reference numerals. There is seen in FIG. 1, a configuration 1A of real estate yard sign 10 with a primary rider sign 24 supported on top of a cross support 22. The cross support 22 also provides support for the main sign 26 which is secured under the cross support 22. A battery pack 28 is shown adjacent to the outer face of the main post 20. This battery pack 28 supplies energy for the rider sign 24 and the main sign 26. Configuration 1B 12 of a sign shows the main post 30 and a cross support 32. A rider sign 34 is shown on top of the cross support 32. A second rider sign 37 and battery pack 38 are supported by the main post 30 in a vertical position. The battery pack 38 provides power for the rider signs 37 and 34 and the main sign 36. Configuration IC of a real estate yard sign shows a main sign 46 and a rider sign 44 supported by the cross support 42. The cross support 42 is attached to and is supported by the main post 40. The battery pack 48 provides power for the rider sign 44 and the main sign 46.

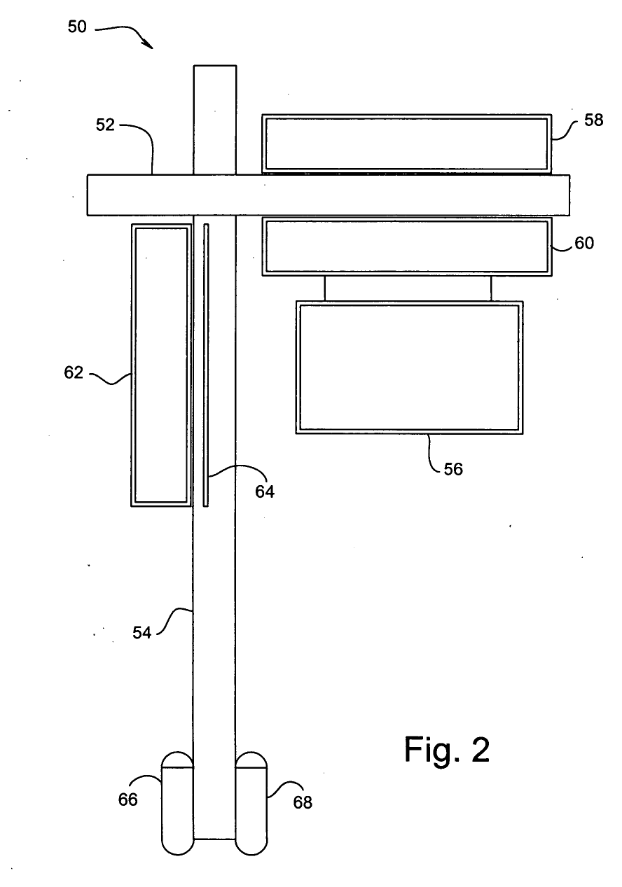

FIG. 2 represents a frontal view of the preferred embodiment of the real estate yard sign 50 according to the present invention, illustrating the real estate yard sign 50 with the cross support 52 and the main post 54 providing support for the primary rider sign 58, secondary rider sign 60 and the main sign 56. The vertical rider sign 62 and vertical rider sign 64 are attached to the main post 54. Energy for illumination of the main rider sign 58, secondary rider sign 60, and the vertical rider sign 62 and vertical rider sign 64 and main sign 56 are provided by the battery pack 66 and the battery pack 68.

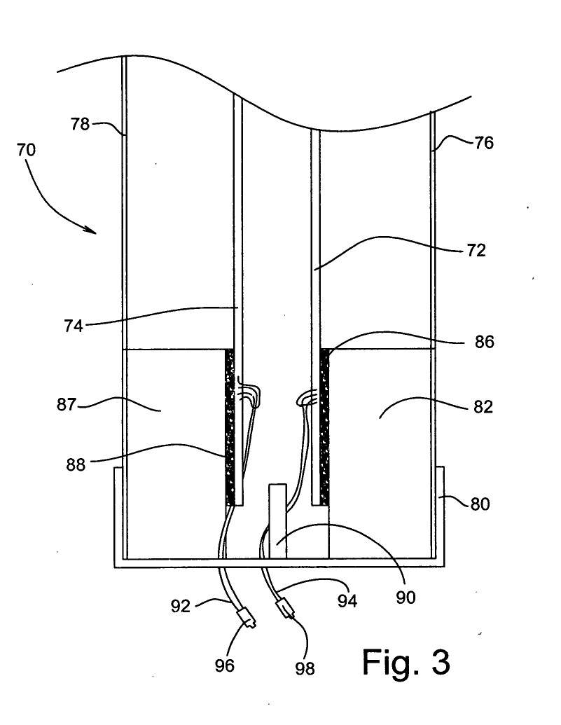

FIG. 3 is a partial cross-sectional view of a double-sided sign frame and double flat light source mount 70. The flat light sources 72 and 74 are protected from the elements by plastic transparent covers/sign 76 and 78. The frame 80 contains block supports 82 and 84. Velcro fasteners 86 and 88 provide a mount for block supports 82 and 84. A center divider provides support for the flat light sources 72 and 74. Power supply wires 92 and 94 are secured by wiring connectors 96 and 98.

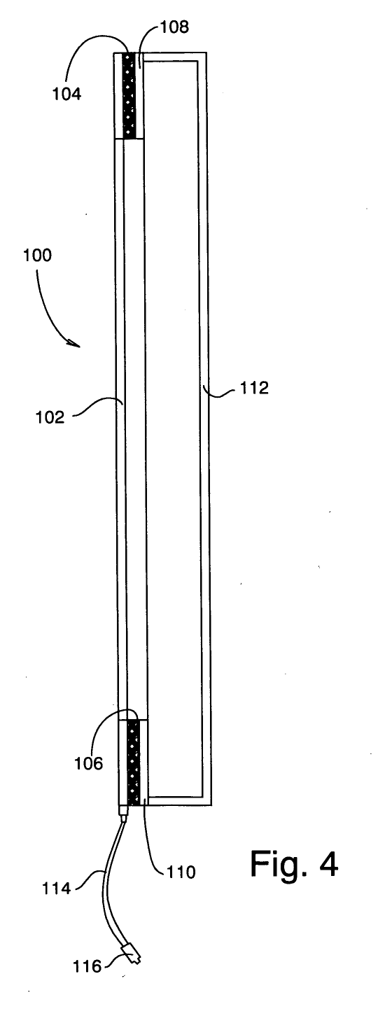

A cross-sectional single-sided sign frame and single flat light source mount 100 is seen in FIG. 4. A flat light source 102 is shown. Velcro fasteners 104 and 106 secure the flat light source 102, matte frames 108 and 110 in position. A plexiglass or glass transparent cover/sign 112 is back lit by the flat light source 102. A lead wire 114 supplies power for the flat light source 102 via wiring connector 116.

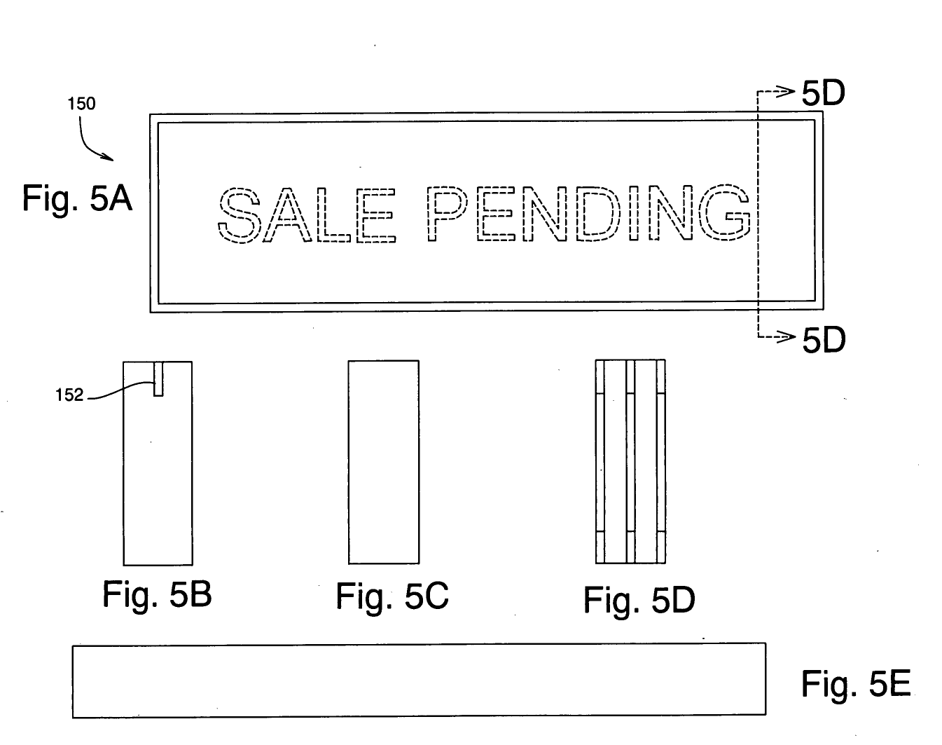

A main sign frame 150 is shown in FIG. 5. A cross section of the sign reveals a center divider 152.

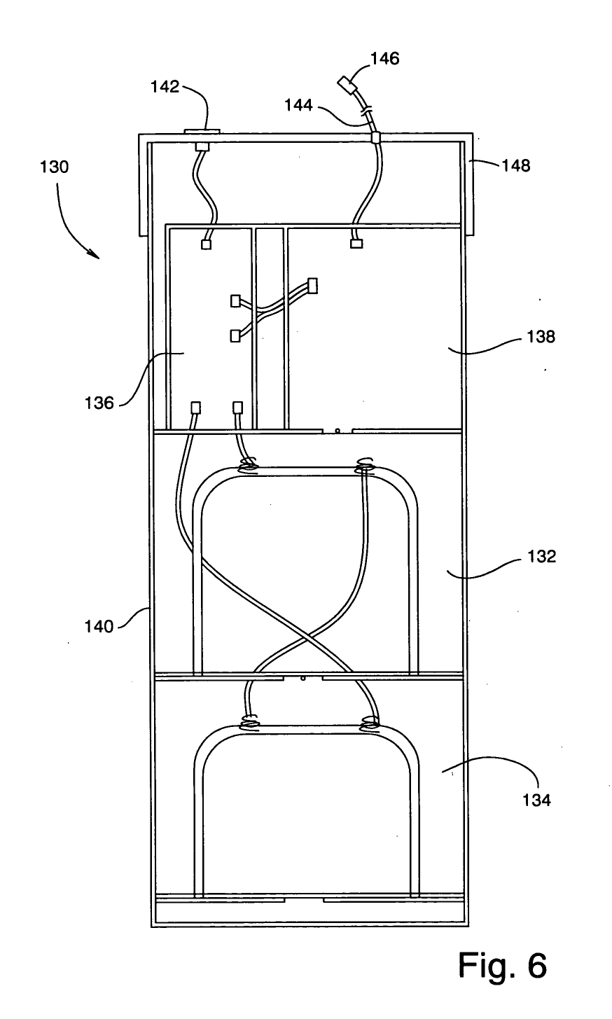

FIG. 6 illustrates a cross-sectional view of a battery pack 130. Two 6-volt batteries 132 and 134 provide power for a printed circuit board. An inverter 138 (please explain exactly how this works). A battery pack housing 140 protects the batteries 132 and 134. A sensor 142 is located on the top of the battery pack housing. Power supply wires 144 with a connector 146 pass through a sealed opening in the housing cover 148.

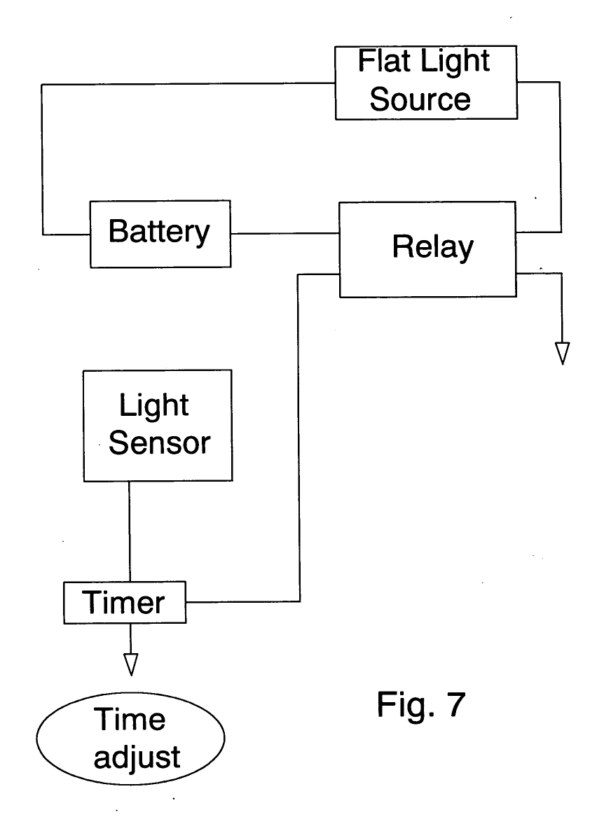

FIG. 7 is a block diagram illustrating the basic wiring logic of the flat light source, light sensor and timer, constructed in accordance with the present invention. A relay acts to switch power from the battery to the flat light source. An inverter (not shown) allows 12 volt DC batteries to provide the flat light source with AC current. The typical flat light source is a light emitting capacitor technology flat panel light bulb, such as that available from the Ceelite™ Company (www.ceelite.com), and runs on approximately 380 volts AC. A light sensor and timer can be included. The circuit can be set to switch on in low light conditions and switch off in brighter light conditions, such as when daylight returns to signs placed outdoors, etc. In addition, the time interval can be adjusted to any time period to keep the flat light source on in numerous applications.

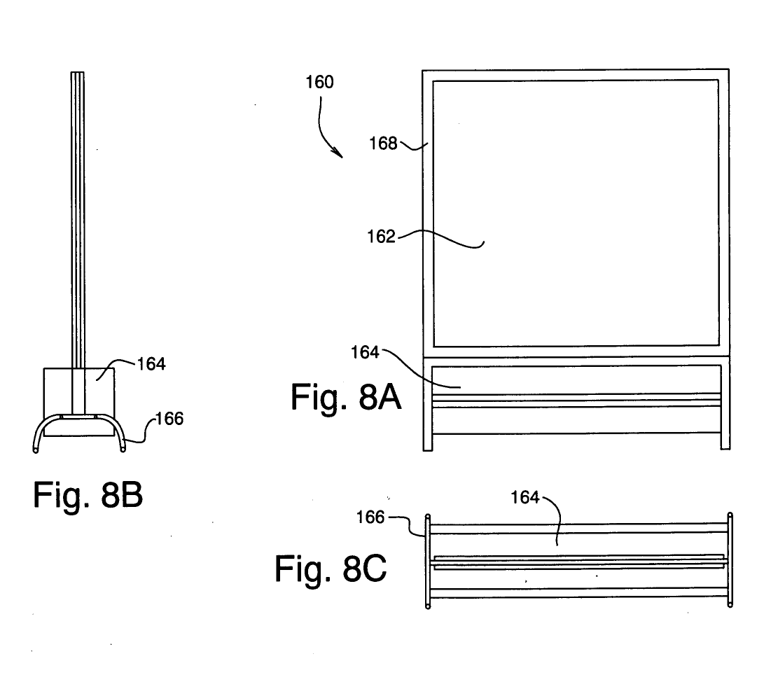

In the next several drawing figures, several embodiments of sign configurations which utilize the novel flat light source/sign display combinations are shown. A sidewalk sign 160 is seen in FIG. 8. The main sign face 162 and battery pack 164 are supported by a stand 166. The main sign frame 168 secures the sign 160 and battery pack 164.

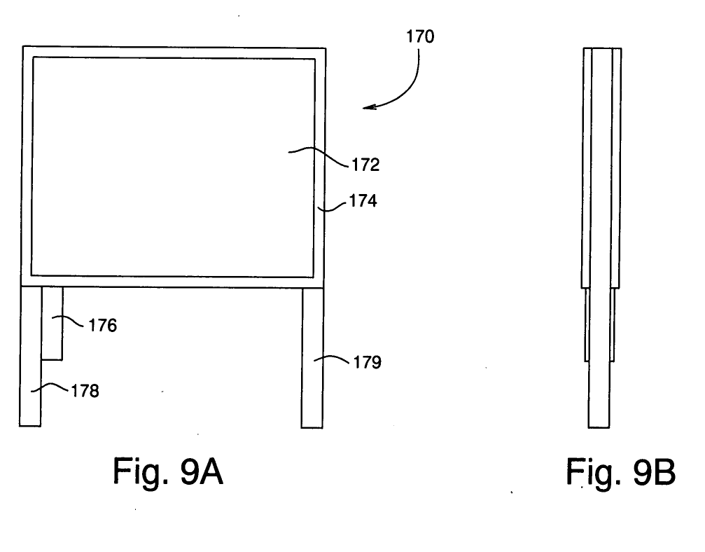

A double-post sign 170 is seen in FIG. 9. The main sign face 172, the main sign frame 174, and the battery pack 176 are supported by support posts 178 and 179.

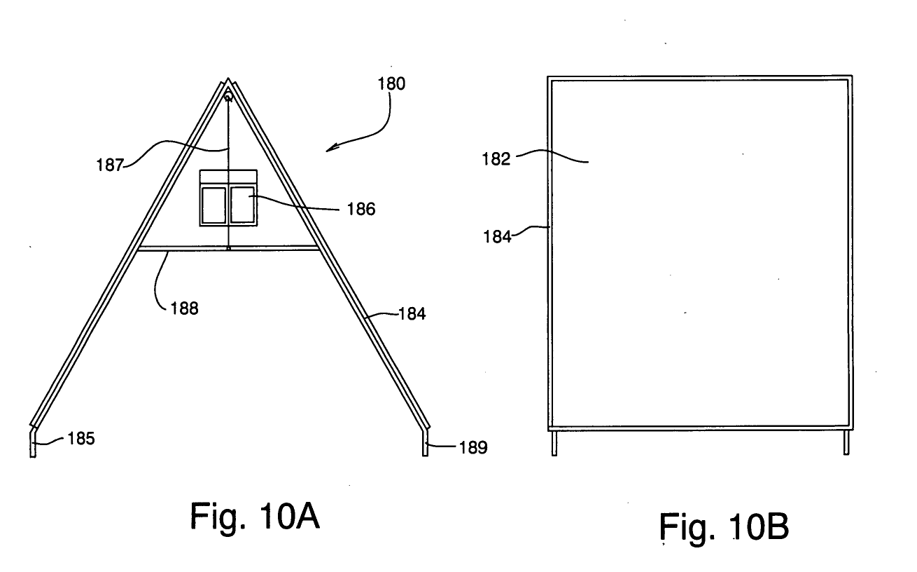

A sandwich sign 180 is seen in FIG. 10. The main sign face 182 and sign frame 184 are supported by support legs 185 and 189. A battery pack 186 provides energy for the sandwich sign 180. A vertical support rod 187 and a horizontal support secure the sandwich sign 180 in place.

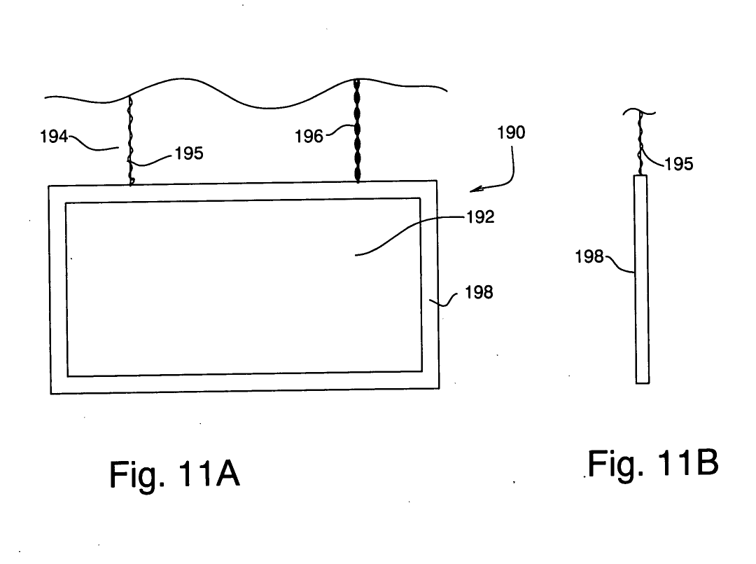

A hanging sign 190 is seen in FIG. 11. The main sign face 192 and sign frame 198 are supported by wire support with power supply wire 194 and a chain sign support 196.

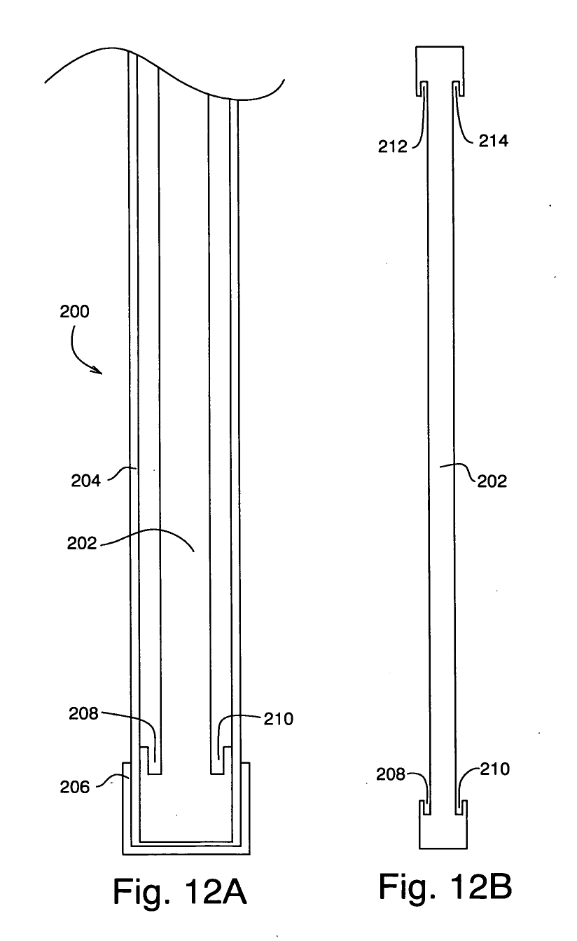

FIG. 12 shows an embodiment of a double slide mount sign 200 with slotted slide insert 202, frame outer covering 204. The end cap 206 holds the slotted slide insert 202 in place. The slots 208, 210, 212, and 214 may accommodate signage.

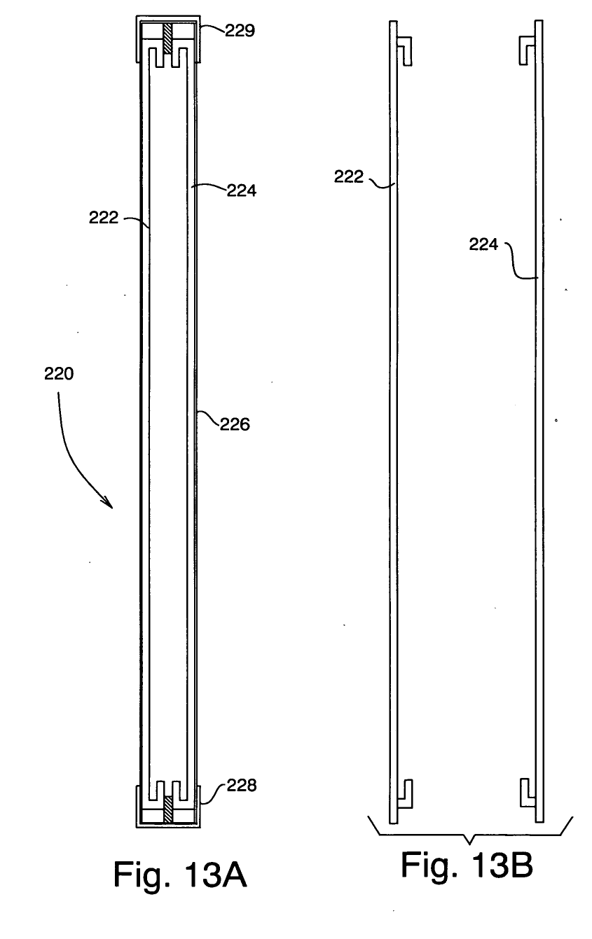

FIG. 13 is a second embodiment of a double slide mount sign 220. The internal slotted slide inserts 222 and 224 are protected by frame outer covering 226 and the end caps 228 and 229.

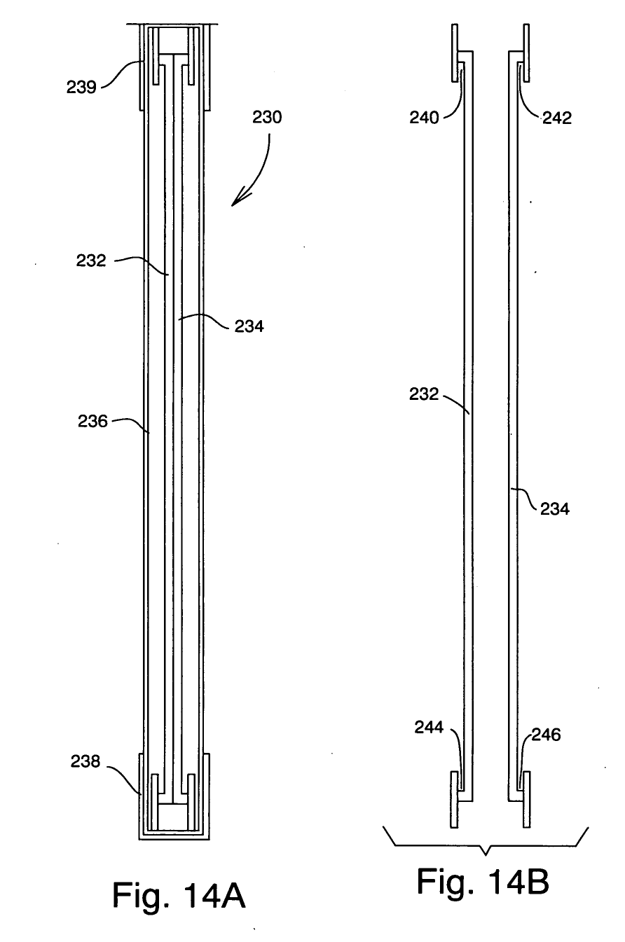

FIG. 14 is a third embodiment of a double slide mount sign in accordance with the present invention with internal slotted slide inserts 232 and 234. A frame outer covering 236 and end caps 238 and 239 protect the sign from the elements. Slots 240, 242, 244, and 246 may accommodate signage.

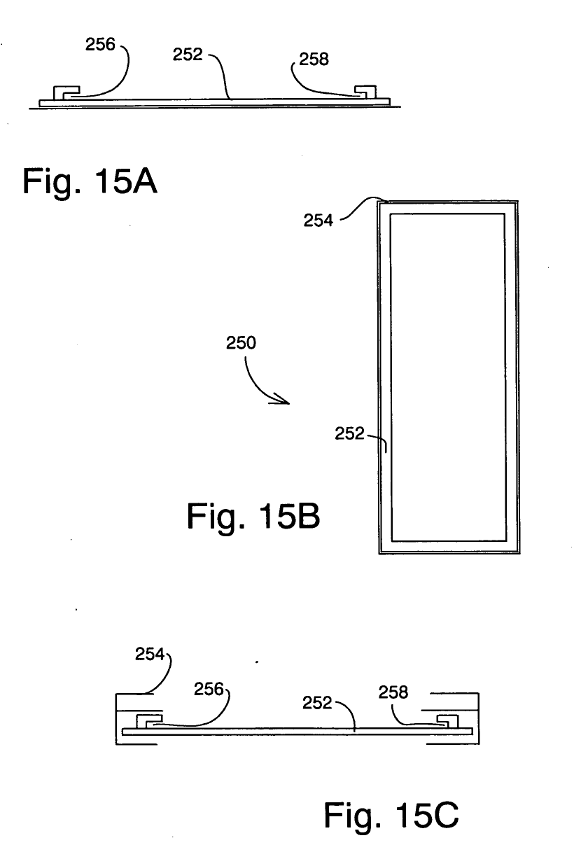

FIG. 15 is an embodiment of a single insert slide mount sign 250 with an internal slotted frame 252 and an outer main frame. Slots 256 and 258 are available to accommodate signage.

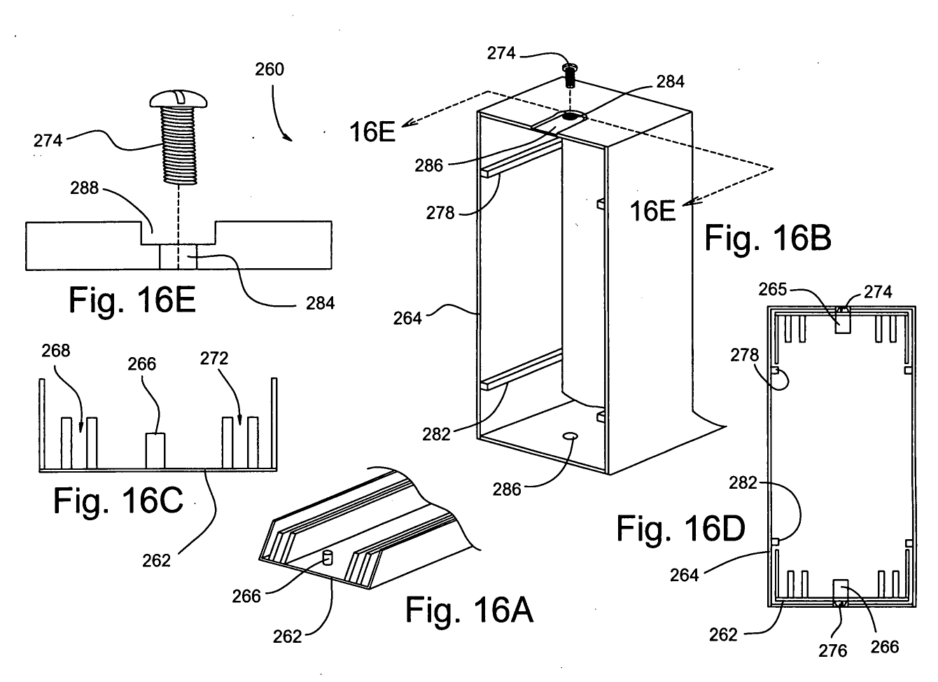

FIG. 16 illustrates an alternate embodiment of a sign frame 260 including upper and lower frame members, as depicted by frame member 262. The frame members are held together by two end caps, as depicted by end cap 264. Each frame member 262 includes a threaded well 266 and slots 268 and 272. The flat light source sign (not shown) is slid into one or both slots 268 and 272, before the end caps are fastened into place using upper screw 274 and lower screw 276. Rail guides, as illustrated by rail guide 278 and rail guide 282, located on both sides of the end cap 264, act to hold the frame member 272 in place. Upper screw 274 passes through screw hole 284 and rests in recess 288, after being threaded into threaded well 265. Like wise lower screw 276 acts to fasten the end cap 264 by passing through hole 286 and threading into threaded well 266. The end caps are fastened to the frame members after each sign has been slid into place in the slots, as exemplified by slots 268 and 272.

In this and all other sign configurations described herein, the signs slid into the frame are either a flat light source and transparent sign sandwiched together, that is, a two piece combination, or a flat light source having a transparent sign integrated thereon, that is, a one piece sign/flat light source combination. In either case, the sign portion may be plastic, cellulose, or some other transparent material. In the one piece combination, the sign portion is lettered prior to being fused together with the flat light source. With the two piece combination, the sign may be pre-made, then subsequently combined with the flat light source at the time of display.

Electric signs with flat light source shown in the drawings and described in detail herein disclose arrangements of elements of particular construction and configuration for illustrating the preferred embodiment of structure and method of construction of the present invention. It is to be understood however, that elements of different construction and configuration and other arrangements thereof, other than those illustrated and described may be employed for providing an electric sign with independent light source in accordance with the spirit of this invention, and such changes, alternations and modifications as would occur to those skilled in the art are considered to be within the scope of this invention as broadly defined in the claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. An electrically powered sign comprising:
(a) a flat transparent sign display panel containing an alphanumeric and/or graphic sign message;
(b) a flat light source placed in close proximity to said sign display panel;
(c) a frame supporting said flat light source and said sign display such that said flat light source, when powered on, shines light through said sign display making the sign message visible in low light conditions; and
(d) a serviceable portable power source to provide electrical power to said flat light source, attached to said frame;
whereby the electrically powered sign is self-contained and portable and capable of being placed anywhere for displaying said sign display.

2. The electrically powered sign according to claim 1, wherein said flat light source is a light emitting capacitor (LEC) electroluminescent (EL) flat panel light bulb.

3. The electrically powered sign according to claim 1, wherein said frame supporting said sign display and said flat light source is mounted on a sign post.

4. The electrically powered sign according to claim 3, wherein said sign display and said flat light source are incorporated into a real estate rider sign.

5. The electrically powered sign according to claim 1, wherein said frame supporting said flat light source and said sign display includes one or more slots, such that said flat light source and said sign display can be slid into said frame, and secured therein.

6. The electrically powered sign according to claim 1, wherein said serviceable portable power source to provide electrical power to said flat light source includes a weatherproof battery pack.

7. The electrically powered sign according to claim 6, wherein said battery pack includes one or more removable batteries, and is serviceable in that said one or more batteries may be replaced when necessary.

8. The electrically powered sign according to claim 6, wherein said battery pack includes one or more rechargeable batteries connected to a solar cell configured to recharge said batteries during daylight times.

9. The electrically powered sign according to claim 1, wherein said serviceable portable power source to provide electrical power to said flat light source includes a light sensor for the purpose of automatically switching on said flat light source during low light conditions and switching off said flat light source during daylight times.

10. A method for making an electrically powered sign comprising the steps of:
(a) providing a flat transparent sign display panel containing an alphanumeric and/or graphic sign message;
(b) providing a flat light source placed in close proximity to said sign display panel;
(c) providing a frame supporting said flat light source and said sign display such that said flat light source, when powered on, shines light through said sign display making the sign message visible in low light conditions; and
(d) providing a serviceable portable power source to provide electrical power to said flat light source, attached to said frame;
whereby the electrically powered sign is self-contained and portable and capable of being placed anywhere for displaying said sign display.

11. The method for making an electrically powered sign according to claim 10, wherein said step of providing a flat light source includes the step of providing a light emitting capacitor (LEC) electroluminescent (EL) flat panel light bulb.

12. The method for making an electrically powered sign according to claim 10, wherein said step of providing a frame supporting said flat light source and said sign display, includes the step of providing a frame comprising:
(a) two frame members having slots for accepting one or more combination flat light source and sign displays;
(b) two end caps fastened to both ends of said frame members for the purpose of securing said combination flat light source and sign display within the frame.

13. The method for making an electrically powered sign according to claim 10, wherein said step of providing a serviceable portable power source includes providing a weatherproof battery pack containing one or more batteries.

14. The method for making an electrically powered sign according to claim 13, wherein said step of providing a weatherproof battery pack containing one or more batteries includes one or more rechargeable batteries connected to a solar cell configured to recharge said batteries during daylight times.

15. The method for making an electrically powered sign according to claim 10, wherein said step of providing a serviceable portable power source includes connecting a light sensor to said power source, for the purpose of automatically switching on said flat light source during low light conditions and switching off said flat light source during daylight times.

16. The method for making an electrically powered sign according to claim 10, wherein said step of providing a flat transparent sign display panel containing an alphanumeric sign message, and said step of providing a flat light source placed in close proximity to said sign display panel, includes providing a sign display panel directly affixed to said flat panel light display, thereby making a combination sign display panel/flat light source single component, to be secured within said frame.

17. The method for making an electrically powered sign according to claim 10, wherein said step of providing a frame supporting said flat light source and said sign display, includes providing a real estate rider sign frame mounted on a sign post.

18. A frame for supporting a combination flat light source/sign display panel comprising:
(a) two frame members having one or more slots for accepting one or more combination flat light source and sign displays;
(b) two end caps fastened to both ends of said frame members for the purpose of securing said combination flat light source/sign display panel within the frame;
whereby the combination flat light source/sign display panel secured within said frame can be replaced by removing one end cap and sliding the existing combination flat light source and sign display out of the frame slots and replacing it with a replacement combination flat light source/sign display panel.

19. The frame for supporting a combination flat light source/sign display panel according to claim 18, wherein said combination flat light source/sign display panel includes two components comprising:
(a) a light emitting capacitor (LEC) electroluminescent (EL) flat panel light bulb; and
(b) a flat transparent sign display panel containing an alphanumeric sign message;
whereby said light emitting capacitor (LEC) electroluminescent (EL) flat panel light bulb is placed in close proximity to said flat transparent sign display panel such that when powered on said flat panel light bulb illuminates said sign display panel making the alphanumeric sign message visible in low light conditions.

20. The frame for supporting a combination flat light source/sign display panel according to claim 18, wherein said combination flat light source/sign display panel includes one component comprising:
(a) a light emitting capacitor (LEC) electroluminescent (EL) flat panel light bulb directly affixed to a flat transparent sign display panel containing an alphanumeric sign message;
whereby said light emitting capacitor (LEC) electroluminescent (EL) flat panel light bulb is placed in close proximity to said flat transparent sign display panel such that when powered on said flat panel light bulb illuminates said sign display panel making the alphanumeric sign message visible in low light conditions.
